(19) United States
(12) Patent Application Publication
(10) Pub. No.: US 2009/0051705 A1
(43) Pub. Date: Feb. 26, 2009

(54) METHOD FOR AUTOMATICALLY MEMORIZING PICTURE ORIENTATION

(76) Inventors: Shih-Kuang TSAI, Shanghai City (CN); Jing-Xin Liang, Shanghai City (CN)

Correspondence Address: Muncy, Geissler, Olds & Lowe, PLLC, P.O. BOX 1364, FAIRFAX, VA, 22038-1364, US

(21) Appl. No.: 12/194,089

(22) Filed: Aug. 19, 2008

(30) Foreign Application Priority Data
Aug. 20, 2007 (TW) 96130777

(51) Int. Cl. G09G 5/00

(52) U.S. Cl. 345/650

(57) ABSTRACT

A method for automatically memorizing a picture orientation is disclosed. In this method, picture data are activated to display a picture image, and then the picture image is rotated by a display angle. After a picture feature based on the picture data is obtained, a feature record comprising the display angle and the picture feature is created. When the picture data are activated again, the feature record is provided, and then the picture image is displayed according to the feature record.

### RELATED APPLICATIONS

This application claims priority to Taiwan Application Serial Number 96130777, filed Aug. 20, 2007, which is herein incorporated by reference.

### BACKGROUND

1. Field of Invention

The present invention relates to a method for automatically memorizing a picture orientation. More particularly, the present invention relates to the method for automatically memorizing a picture image's display angle by which the picture image was rotated in the previous activation.

2. Description of Related Art

With the popularity of digital technology, since digital cameras are easily to be operated and the pictures taken thereby can be readily shown on the displays of the digital cameras or on computer screens, most of the cameras in the market are digital cameras. Many of the digital pictures shot by the digital cameras are normally stored in memory cards, compact disc read-only memory (CD-ROM) or hard disks in computers, and are not convenient to be viewed. Hence, digital photo frames are presented to the market for displaying digital pictures with their liquid crystal display (LCD) screens.

When using a digital camera to take a digital picture, for finding a better view, a photographer sometimes has to turn the digital camera to a specific angle, and thus the digital picture taken thereby also shows an image rotated by the specific angle when being shown on a digital photo frame. Thus, a user has to rotate the digital photo frame to adjust its orientation for viewing the digital picture conveniently. However, when the user desires to view the same digital picture again, he or she has to rotate the digital photo frame again, thus causing quite inconvenience for viewing the digital picture repeatedly.

### SUMMARY

Hence, an aspect of the present invention is to provide a method for automatically memorizing a picture orientation by automatically recording a picture image's display angle by which the picture image was rotated in the previous activation; and automatically displaying the picture image in accordance with the display angle, thereby promoting the convenience of viewing the picture image.

In accordance with an embodiment, the method for automatically memorizing a picture orientation comprises: activating picture data to display a picture image; rotating the picture image by a display angle; obtaining a picture feature based on the picture data which are disposed for the rotated picture image; creating a feature record comprising the display angle and the picture feature; and when the picture data are activated again for displaying, providing the feature record and then displaying the rotated picture image according to the feature record.

Hence, the method for automatically memorizing a picture orientation of the present invention can automatically display a picture image in accordance with a display angle previously stored, and also save storage space.

It is to be understood that both the foregoing general description and the following detailed description are examples, and are intended to provide further explanation of the invention as claimed.

### BRIEF DESCRIPTION OF THE DRAWINGS

These and other features, aspects, and advantages of the present invention will become better understood with regard to the following description, appended claims, and accompanying drawings where:

FIG. 1 is a schematic flow chart showing a method for automatically memorizing a picture orientation according to an embodiment of the present invention;

FIG. 2 is a schematic front view showing a picture display apparatus according to the embodiment of the present invention;

FIG. 3 is a schematic block diagram showing the method for automatically memorizing a picture orientation according to the embodiment of the present invention;

FIG. 4 is a schematic diagram showing the data relationship in the method for automatically memorizing a picture orientation according to the embodiment of the present invention; and

FIG. 5 is a schematic flow chart showing a step of providing the feature record according to the embodiment of the present invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

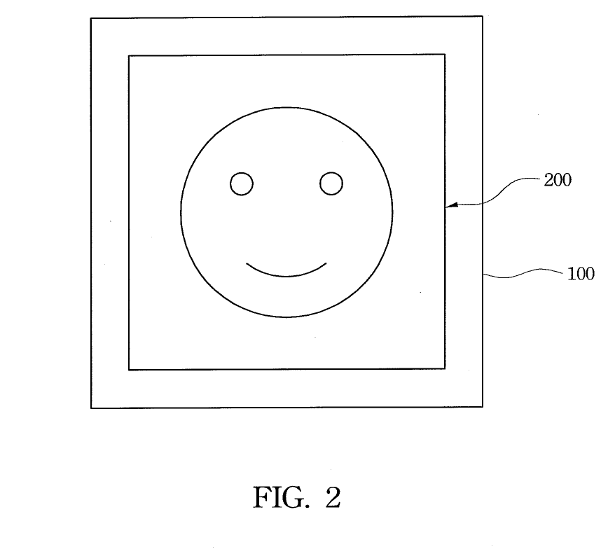

Referring to FIG. 2, FIG. 2 is a schematic front view showing a picture display apparatus according to the embodiment of the present invention. The method of this embodiment can be applied to a picture display apparatus 100 for automatically memorizing the display angle or orientation of a picture image 200, whereby when the same picture image 200 is activated again for displaying, the picture display apparatus 100 can automatically display the picture image 200 rotated in accordance with the display angle previously stored, so that a user does not need to rotate the picture image 200 again for convenient viewing.

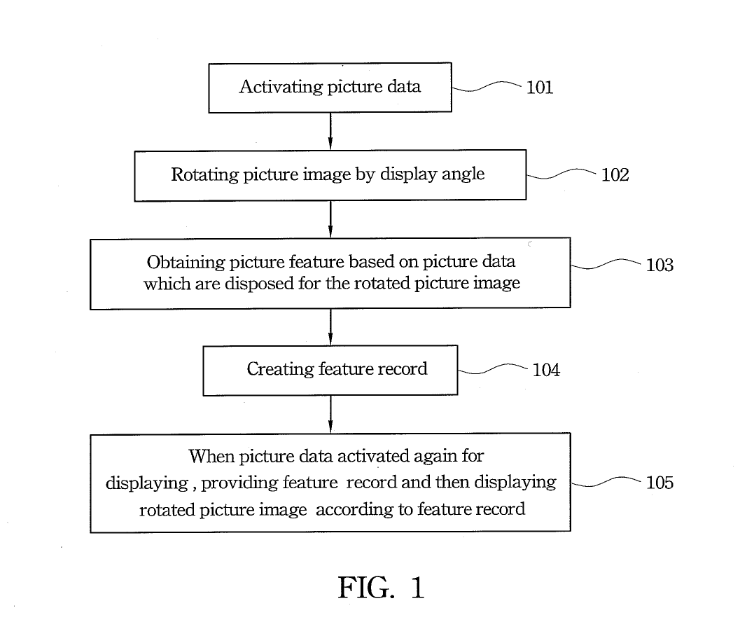

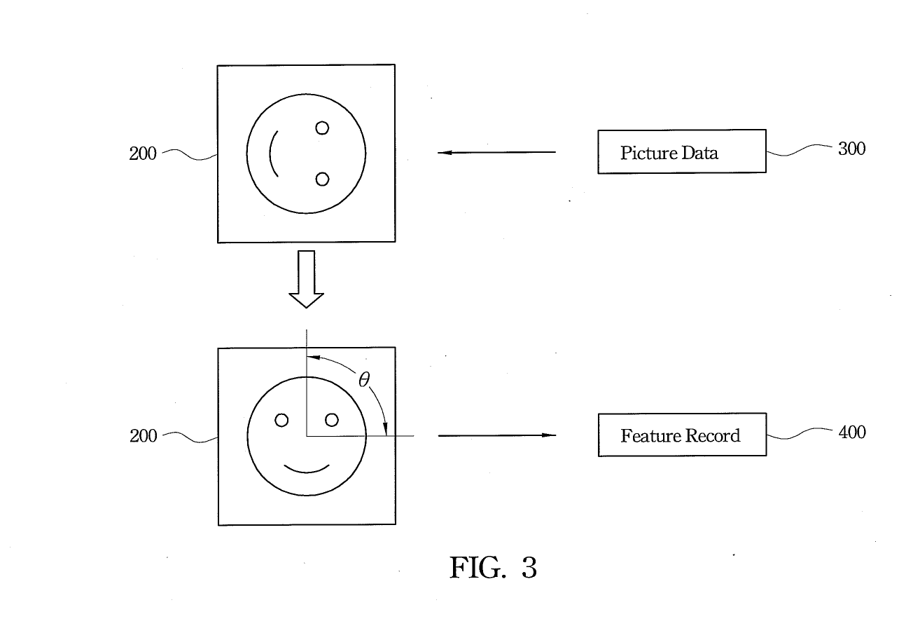

Referring to FIG. 1, FIG. 2 and FIG. 3, FIG. 1 is a schematic flow chart showing a method for automatically memorizing a picture orientation according to an embodiment of the present invention; FIG. 3 is a schematic block diagram showing the method for automatically memorizing a picture orientation according to the embodiment of the present invention. In the method of the present embodiment, at first, picture data 300 are activated to display the picture image 200 (step 101). The picture data 300 are stored in the picture display apparatus 100 such as a digital photo frame, and the picture image 200 formed by the picture data 300 is displayed with the picture display apparatus 100. The picture data 300 are in a data format such as JPEG (Joint Photographic Experts Group), GIF (Graphics Interchange Format), MPG1 (Moving Pictures Expert Group), MPG2, MPG4, DIVX (Digital Video Express) or AVI (Audio Video Interleave), etc., for displaying the static or dynamic picture image 200.

Then, a user rotates the picture image 200 by a display angle for convenient viewing (step 102). For example, the original picture image 200 cannot to be viewed conveniently due to a particular shooting angle, and thus the original picture image 200 has to be rotate by a display angle θ (such as 90 degrees) for viewing convenience.

Thereafter, a picture feature based on the picture data 300 which are disposed for the rotated picture image is obtained (step 103). Then, a feature record 400 is created (step 104), wherein the feature record 400 comprises the picture feature and the display angle θ at which the original picture image 200 is desired to be rotated, and thus the display angle θ can be stored in the feature record 400. When the picture display apparatus 100 has stored a plurality of sets of picture data (including the set of picture data 300) at the same time, the sets of picture data has their respective feature records which are different from each other, so that the picture features of the feature records can be used to distinguish whether the feature record 400 is corresponding to the set of picture data 300.

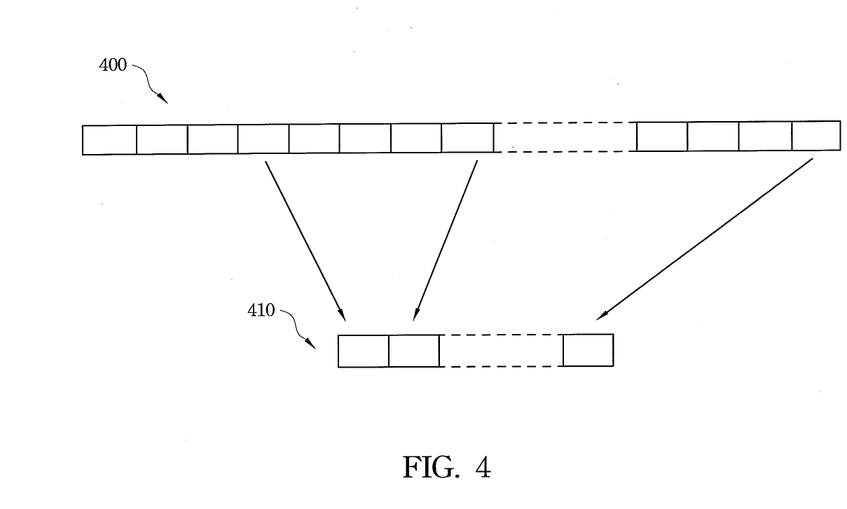

Referring to FIG. 1 and FIG. 4, FIG. 4 is a schematic diagram showing the data relationship in the method for automatically memorizing a picture orientation according to the embodiment of the present invention. For example, in this embodiment, when step 103 is used to obtain a picture feature 410 from the picture data 300 which are disposed for the rotated picture image, the picture data 300 can be formed in a sequence of bytes, and the length of the sequence of bytes is about greater than 100 k, and counted from the start of the sequence of bytes, one byte of data at the end of every a certain number of consecutive bytes (such as 128 bytes) of the sequence of bytes is retrieved, and thereby about 64 bytes of data are obtained, and then those 64 bytes of data can be used to form the picture feature 410 of the feature record 400.

After the feature record 400 is built, when the picture data 300 are activated again for displaying, the feature record 400 is first provided, and then the picture image 200 is displayed according to the feature record 400 (step 105).

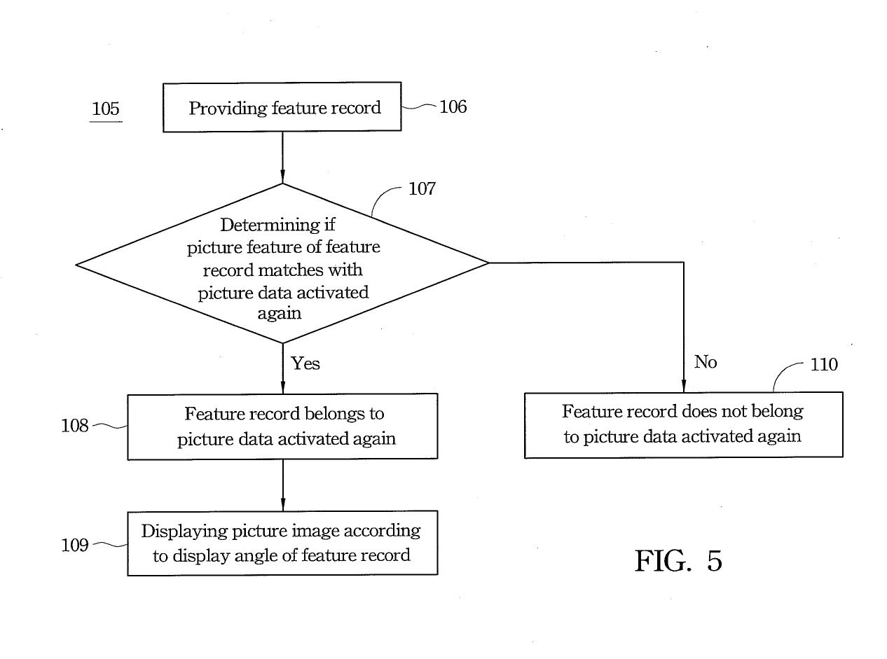

Referring to FIG. 4 and FIG. 5, FIG. 5 is a schematic flow chart showing a step of providing the feature record according to the embodiment of the present invention. In the step 105 of FIG. 1, when the feature record 400 is provided (step 106), step 107 is performed for determining if the picture feature 410 of the feature record 400 matches with the picture data 300. When the result of the determining step 107 is yes, it is determined that the feature record 400 belongs to the picture data 300 activated again (step 108), otherwise it is determined that the feature record 400 does not belong to the picture data 300 activated (step 110). Hence, when the picture display apparatus 100 (FIG. 2) have stored a plurality of sets of picture data, step 105 (steps 107) can be used to determine if the feature record provided is corresponding to the set of picture data just activated.

After it is confirmed that the feature record 400 is corresponding to the picture data 300, the picture image 200 (FIG. 2) of the picture data 300 is displayed according to the display angle θ of the feature record 400 (step 109), i.e. the picture image 200 can be automatically rotated by the display angle θ used in the last activation. Hence, the method of the present embodiment can automatically memorize the previous orientation of the picture image 200 or the rotation (display) angle by which the picture image 200 was rotated previously, and when the picture data 300 is activated again for displaying, the display angle θ previously recorded will be used for displaying the picture image 200, thereby promoting the convenience for viewing the picture image. Moreover, the feature record 400 adopted in the present embodiment does not occupy too much data storage space, thus avoiding affecting the performance of the picture display apparatus 100 (FIG. 2). Further, the method the present embodiment can automatically base on the feature record 400 to display the picture image 200. Therefore, even if the title of picture data 300 is renamed or the picture data are copied several times, the picture display apparatus 100 still can automatically use the previously-recorded display (rotation) angle to display the image from the picture data 300.

It can be known from the embodiment described above, the method of the present invention can automatically base on the previously-recorded rotation angles to display picture images, thereby promoting the convenience of viewing pictures; can reduce the data storage space; and still can display picture images by using the previously-recorded rotation angles even if the picture data are copied or renamed.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for automatically memorizing a picture orientation, the method comprising:
activating picture data to display a picture image;
rotating the picture image by a display angle;
obtaining a picture feature based on the picture data which are disposed for the rotated picture image;
creating a feature record comprising the display angle and the picture feature; and
when the picture data are activated again for displaying, providing the feature record and then displaying the rotated picture image according to the feature record.

2. The method as claimed in claim 1, wherein the picture data are stored in a picture display apparatus, and the picture image is displayed with the picture display apparatus.

3. The method as claimed in claim 2, wherein the picture display apparatus is a digital photo frame.

4. The method as claimed in claim 1, wherein the picture data are in a data format selected from the group consisting of JPEG (Joint Photographic Experts Group), GIF (Graphics Interchange Format), MPG1 (Moving Pictures Expert Group), MPG2, MPG4, DIVX (Digital Video Express) and AVI (Audio Video Interleave).

5. The method as claimed in claim 1, wherein the step of obtaining the picture feature comprises:
when the picture data are formed in a sequence of bytes, retrieving one byte of data at the end of every a certain number of consecutive bytes of the sequence of bytes counted from the start of the sequence of bytes.

6. The method as claimed in claim 5, wherein the step of obtaining the picture feature retrieves one byte of data at the end of every 128 bytes of the sequence of bytes counted from the start of the sequence of bytes.

7. The method as claimed in claim 1, wherein the step of providing the feature record comprises:
determining if the picture feature of the feature record matches with the picture data, wherein when the result of the determining step is yes, the feature record belongs to the picture data activated again, otherwise the feature record does not belong to the picture data activated again.

8. A method for automatically memorizing a picture orientation, the method comprising:
activating picture data stored in a picture display apparatus to display a picture image;
rotating the picture image by a display angle;
obtaining a picture feature based on the picture data which are disposed for the rotated picture image, wherein the step of obtaining the picture feature comprises:
when the picture data are formed in a sequence of bytes, retrieving one byte of data at the end of every a certain number of bytes of the sequence of bytes counted from the start of the sequence of bytes, thereby retrieving a plurality of bytes of data which become the picture feature;
creating a feature record comprising the display angle and the picture feature; and
when the picture data are activated again for displaying, providing the feature record and then displaying the rotated picture image according to the feature record.

9. The method as claimed in claim 8, wherein the picture display apparatus is a digital photo frame.

10. The method as claimed in claim 8, wherein the picture data are in a data format selected from the group consisting of JPEG, GIF, MPG1, MPG2, MPG4, DIVX and AVI.

11. The method as claimed in claim 8, wherein the step of obtaining the picture feature retrieves one byte of data at the end of every 128 bytes of the sequence of bytes counted from the start of the sequence of bytes.

12. The method as claimed in claim 8, wherein the step of providing the feature record comprises:
determining if the picture feature of the feature record matches with the picture data, wherein when the result of the determining step is yes, the feature record belongs to the picture data activated again, otherwise the feature record does not belong to the picture data activated again.
